(19) United States
(12) Patent Application Publication
(10) Pub. No.: US 2009/0089685 A1
(43) Pub. Date: Apr. 2, 2009

(54) System and Method of Communicating Between A Virtual World and Real World

(76) Inventors: Nicole Y. Mordecai, Weston, MA (US); Jonathan H. Kaplan, Newton, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/129,802

(22) Filed: May 30, 2008

Related U.S. Application Data
(60) Provisional application No. 60/976,195, filed on Sep. 28, 2007.

(51) Int. Cl. G06F 3/048; H04N 7/14

(52) U.S. Cl. 715/757; 348/14.01; 348/E07.078

(57) ABSTRACT

A system allows for a real world person to make and receive a real world phone call using virtual world tools. The system runs software for rendering a virtual environment in which users at workstations in the real world are represented by avatars in the virtual world. The virtual world software of the present system is interconnected via a network to a private and public telephone network to allow a connection between a virtual and real world phone system. The virtual world embodiment of the communication between the virtual world and real world includes a plurality of states by which a conversation is visually and audibly indicated.

### CROSS REFERENCE TO RELATED APPLICATIONS

This application claims priority from: U.S. provisional application Ser. No. 60/976,195, filed Sep. 28, 2007, entitled “A SYSTEM AND METHOD OF COMMUNICATING BETWEEN A VIRTUAL WORLD AND REAL WORLD.” The entire contents of the provisional application are hereby incorporated by reference.

### FIELD OF THE INVENTION

The present invention generally relates to systems and methods for interaction in a virtual world, and more particularly, to systems and techniques which provide for interacting between a user navigating in a virtual world and a user in the real world.

### BACKGROUND OF THE INVENTION

A virtual world is a computer model of a three-dimensional space. One type of virtual world is the shared virtual world. A shared virtual world may involve a number of users, each with their own copy of the relevant virtual world application (termed a client) experiencing a three dimensional space which is common to them all. To represent the location of a user in a shared virtual world a special type of entity, known as an avatar, is employed. The avatar typically has a name associated therewith for indication as to the identity of the avatar and/or the real world person controlling the avatar.

In a shared virtual world, each user not only perceives the results of their interactions with the entities (including other avatars) but also the results of other users interactions. A shared virtual world is usually implemented using a computer network wherein remote users operate avatars in the network which incorporates servers for the virtual environment. As each user joins the virtual world a client is provided with the current state of all entities within it. As the environment state changes, due to either user invoked behavior or autonomous behavior, the newly generated state information is distributed to all clients, allowing a common view of the shared virtual world between different clients to be maintained.

An avatar is operable by its user to interact and communicate with other avatars within the virtual world. This can be done publicly (speaking or public chatting using text messages which are displayed to all within a predefined distance) or privately by way of instant messaging (IM). While traditionally users have utilized avatars in virtual worlds for game playing or social networking, the use of virtual environments for conducting business is becoming more popular. Some examples of business uses of a virtual world environment include holding meetings attended by avatars similar to a meeting held in the real world and providing presentations or training sessions attended by avatars representing real world participants.

### SUMMARY

One problem with the present art is that a user who in not interconnected via a workstation to the virtual world may not communicate with other avatars in the virtual world.

The present invention addresses these and other issues concerning the incompatibilities and difficulties encountered by communicating between persons in a virtual world and a person in the real world using telephone equipment.

More specifically, the present invention provides mechanisms and techniques that allow for a real world person to make a real world phone call using virtual world tools. The system runs software for rendering a virtual environment in which users at workstations in the real world are represented by avatars in the virtual world. The virtual world software of the present system is interconnected via a network to a private and public telephone network to allow a connection between a virtual and real world phone system, such that real world persons who do not have a corresponding avatar can communicate with avatars by way of a phone system.

According to one embodiment of the invention, a method is provided for communicating between a representation of a person in a virtual world and a real person in a real world. The method comprises the steps of representing a real world person as an avatar in the virtual world, the avatar controlled by the real world person via an interface link providing access between the real world and the virtual world; and communicating between the avatar representing the real world person in the virtual world using a virtual phone of a virtual phone system and another real world person in the real world using a real world phone of a real world phone system, the virtual phone system and the real world phone system connected via the interface link. The method may further include representing a plurality of other real world persons as a corresponding plurality of avatars in the virtual world, wherein the communication between the avatar in the virtual world representing the real world person using a virtual phone and another real world person using a real world phone of the real world phone system, the communication having selectively one of several states.

One state, “secret”, provides an environment where a representation of communication (e.g. a virtual telephone) is visually hidden from avatars in visual range of the avatar using the virtual phone and any audio is indiscernible to avatars in audio range of the avatar using the virtual phone. Another state, “private”, provides an environment wherein a representation of communication is visually detectable by the avatars in visual range of the avatar using the virtual phone and the audio is indiscernible to other avatars in the audio range of the avatar using the virtual phone. In “secret” and “private” states, users on the phone cannot hear any avatars in audio range of the virtual telephone. Still another state, “public/silent”, provides an environment wherein a representation of communication is visually detectable by the avatars in visual range of the avatar using the virtual phone and the audio is indiscernible to other avatars in the audio range of the avatar using the virtual phone, and wherein the real word person is further indicated by a graphic. Yet another state, “public”, provides an environment wherein a representation of communication is visually detectable by the avatars in visual range of the avatar using the virtual phone and the avatars in audio range of the avatar using the virtual phone can hear the audio and a visually detectable state of a communication is a rendering of an object or a semi-transparent avatar. Yet another state, “public/video”, provides an environment wherein a representation of communication is visually detectable by the avatars in visual range of the avatar using the virtual video conferencing equipment and the avatars in audio range of the avatar using the virtual video conferencing equipment can hear the audio, and see the video, and a visually detectable state of a communication is a rendering of an object or a semi-transparent avatar. In all of the ‘public’ states, users can hear avatars speaking in audio range of the virtual phone. The visual representation of the phone users alerts all users that others can hear them if they are within audio range. Further, the virtual phone of the virtual phone system may be assigned to an object within the virtual world and the virtual phone system is a virtual teleconferencing system. Virtual teleconferencing may involve multiple users on a phone call. It should be noted that the above-mentioned states may also apply to virtual teleconferencing. The virtual object may be a virtual room, an avatar or coordinates within the virtual world.

It should be noted that phone calls can transition from any state to any other state during a live call. For example, a user in a secret call may decide to make the call pubic at any time. Likewise, a public call can become private. Even public/video calls can be transitioned into as long as the video conferencing equipment is available. A user in a virtual world might be in a “public/silent” state using a virtual phone on a video conferencing system, and then transition to a “public/video” state if the party at the other end of the phone had the available video conferencing equipment on their end.

Other embodiments include a computer system configured as a management station to perform all of the aforementioned methods via software control, or via hardware and/or software configured to perform those methods and the techniques disclosed herein as the invention.

One such embodiment includes a system for communicating between a real world person connected to a virtual world and a real world person connected to a real world phone system, the system comprising: a computer that executes one or more computer programs having process instructions stored therein, the computer programs creating a virtual world; an interface link providing access between a real world and the virtual world; a real world phone system; an avatar in the virtual world representing a corresponding person in the real world, the avatar controlled via the interface link by the corresponding real world person; and a virtual phone system connected via the interface link to the real world phone system, the virtual phone system allowing communication between the avatar in the virtual world representing the real world person using a virtual phone and another real world person using a real world phone of the real world phone system.

Other embodiments of the invention that are disclosed herein include software programs to perform the operations summarized above and disclosed in detail below. More particularly, a computer program product is disclosed which has a computer-readable medium including computer program logic encoded thereon to provide the methods for communicating between a representation of a person in a virtual world and a real person in a real world according to this invention and its associated operations. The computer program logic, when executed on at least one processor within a computing system, causes the processor to perform the operations (e.g., the method embodiments above, and described in detail later) indicated herein. This arrangement of the invention is typically provided as software on a computer readable medium such as an optical medium (e.g., CD-ROM), floppy or hard disk or other such medium such as firmware in one or more ROM or RAM or PROM chips or as an Application Specific Integrated Circuit (ASIC). The software or firmware or other such configurations can be installed onto a computer system to cause the computer system to perform the techniques explained herein as the invention.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Sun Microsystems, Inc. of Santa Clara, Calif.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, with emphasis instead being placed upon illustrating the embodiments, principles and concepts of the invention.

FIG. 1 shows a rendering of a virtual world containing a virtual phone.

FIG. 2 shows a block diagram of a system for implementing a virtual world capable of having telephonic communication with real world persons.

FIG. 3 shows a rendering of a room in a virtual world in which a virtual world to real world phone call is placed and there is no indication of the call nor is the conversation heard by any other person in the virtual world (i.e., a ‘secret’ state).

FIG. 4a shows a rendering of a private phone call in which the phone call is visually represented by an avatar using a cell phone, but the phone call is not heard and there is no indication to whom the avatar is speaking (i.e., a ‘private’ state).

FIG. 4b shows a rendering of a room in a virtual world in which a virtual world to real world phone call is placed and there is a visual indication of to whom the avatar is speaking via a virtual cell phone and an object, the phone conversation is not heard by any other avatar in the virtual world (i.e., a ‘public/silent’ state).

FIG. 5 shows a rendering of a room in a virtual world in which a virtual world to real world phone call is placed and there is an indication of the real world person the avatar is communicating with (i.e., a ‘public’ state).

FIG. 6 shows a rendering of a virtual conference room in a virtual world in which a virtual world to real world video-conference call is made (i.e., a ‘public/video’ state).

FIG. 7 shows a flow chart of a particular embodiment of a method of placing a virtual world phone call in accordance with embodiments of the present invention.

FIG. 8 shows a flow chart of a particular embodiment of indicating virtual world phone calls to others in a virtual world in accordance with embodiments of the present invention.

### DETAILED DESCRIPTION

According to example embodiments, a virtual world embodied in hardware and software allows for users in the virtual world to interact with users who are not represented in the virtual world in the conventional manner.

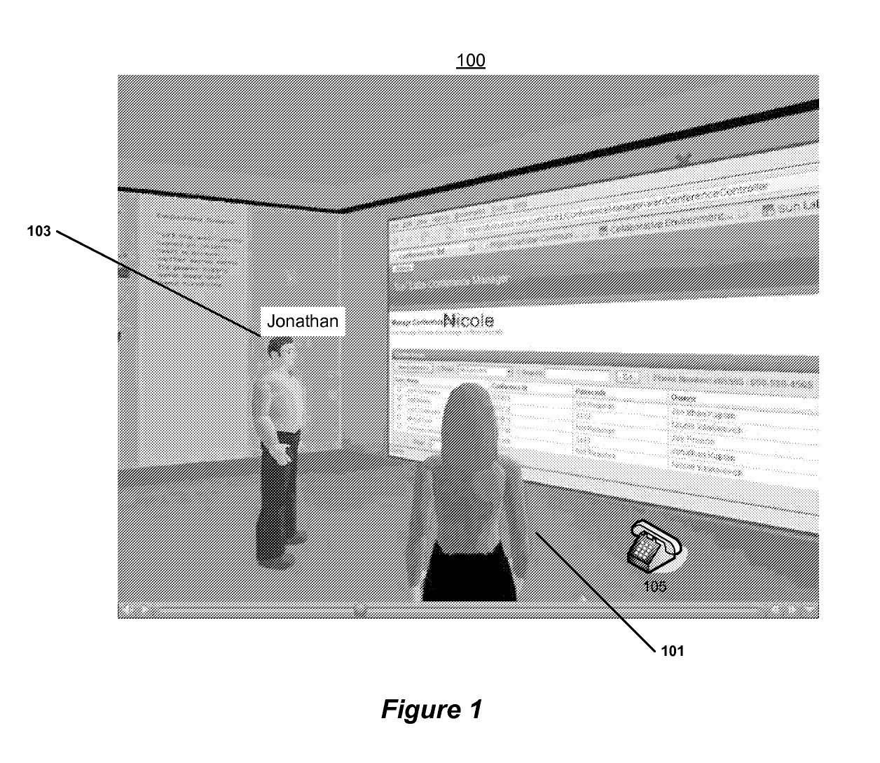

Referring now to FIG. 1, a virtual world environment 100 is shown. The virtual world environment 100 in this example includes a virtual room wherein a first user is represented by a first avatar 101 (Nicole). The avatar 101 is controlled by the user interconnecting from a workstation (not shown), that allows movement and interaction within the virtual world between avatar 101 and another avatar 103 (Jonathan) that is also a representation of another user in the real world. Avatar 103 is also controlled by a user interconnecting from a workstation (not shown), that allows movement and interaction within the virtual world 100. Avatars 101 and 103 can communicate with each other, for example by talking, chatting by public text, or by instant messaging. Chatting by public text means that text messages sent between the avatars 101 and 103 would also be visible to other avatars (if any) in proximity to avatar 101 or avatar 103. Instant messaging is private in that text messages sent between avatar 101 and 103 are only visible to avatars 101 and 103 and are not visible to other avatars in the general vicinity of either avatar 101 or avatar 103.

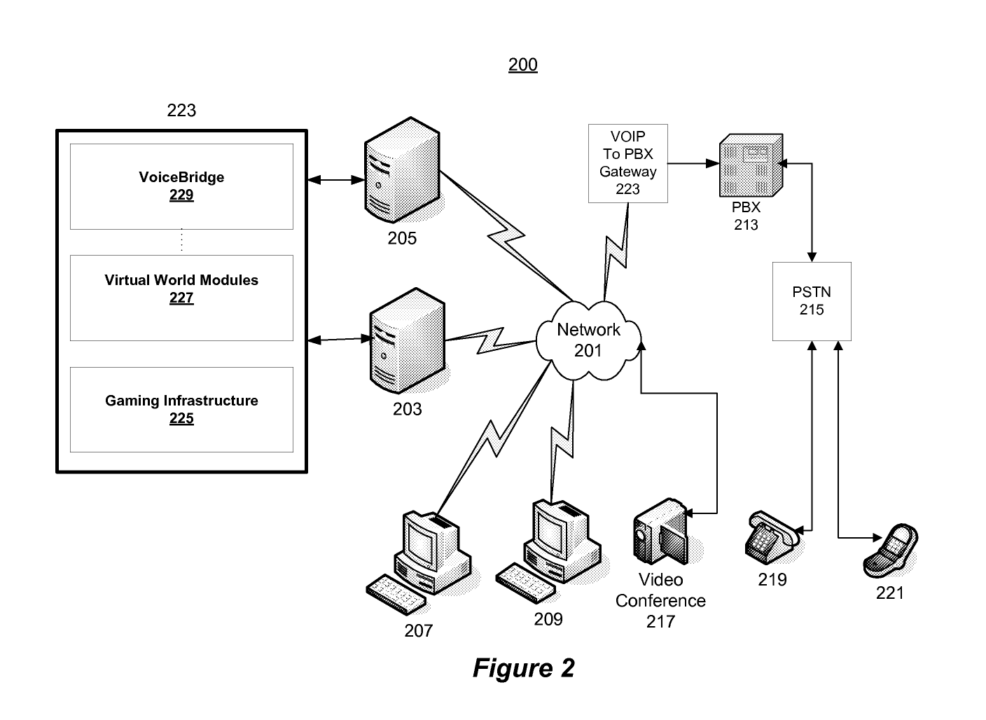

Referring now also to FIG. 2, a block diagram 200 illustrating hardware and software components which provide a virtual world capable of allowing a user represented in a virtual world to speak to users in a real world is shown. Servers 203 and 205 run a distributed virtual world program 223. While two servers are illustrated for brevity, it is clear to those of ordinary skill in the art that such a program could run on a single server or on a plurality of servers. The virtual world software stack is composed of a gaming infrastructure 225 that allows easy development by providing a simple programming model and back-end services for building massively scalable online games.

One example of such a gaming infrastructure 225 is the Project Darkstar Gaming Infrastructure, which is an Open Source project sponsored by Sun Microsystems, of Santa Clara, Calif. Project Wonderland is also an open source project sponsored by Sun. On top of the gaming infrastructure 225 are Virtual World modules 227 that define a virtual world and control the gaming environment. The virtual world program 223 also communicates with a Voice Bridge program 229 to allow interconnection between software and hardware elements. One example of such a Voice Bridge is jVoiceBridge, an open source project sponsored by Sun Microsystems of Santa Clara, Calif. jVoiceBridge is software written in the Java™ Programming Language that handles Voice over IP (VoIP) audio communication and mixing for tasks such as conference calls, video conference calls, voice chat, speech detection, and audio for 3D virtual environments. The jVoiceBridge supports a range of voice qualities from telephone to CD-quality. In addition, the jVoiceBridge supports stereo audio and the ability for each individual connected to the Bridge to have their own private voice mix.

During operation of Virtual World program 223, the virtual world is rendered on workstations 207 and 209. Users sitting at workstation 207 and 209 each manipulate avatars 101 and 103 respectively. Workstations 207 and 209 also have audio communications equipment that allows the avatars 101 and 103 to speak to each other in the virtual environment. Such communications equipment includes speakers and a microphone or other equipment that allows for the receiving and transmitting of audio information. Such communications is transmitted and received over network 201 to and from servers 203 and 205 and workstations 207 and 209. Avatars 101 and 103 can then carry on a conversation in the virtual world as proxies for the real world users sitting at workstations 207 and 209.

During the operation of Virtual World program 223, the avatars 101 and 103 represent the users at workstations 207 and 209. The avatars 101 and 103 have many of same characteristics of users in the real world. The avatars 101 and 103 may walk around virtual room 100 or transit to other virtual rooms (not shown). Like users in the real world when avatar 101 transits to another virtual room, she is no longer in audio range of avatar 103 and must rely on other forms of communications to contact avatar 103 (e.g., instant messaging or the like).

Avatar 101 may place a virtual phone call to avatar 103. Virtual phone 105 in a virtual world has many of the same characteristics as phones in a real world. The avatars 101 and 103 may also make calls from a virtual phone 105 in the virtual world to real world phones 217, 219 and 221 in the real world. The avatar 101 under the direction of the user of workstation 207 dials a real world phone number on virtual phone 105. When a person places a phone call from virtual phone 105, a message is sent from workstation 207 to Virtual World Program 223. On receiving this message, jVoiceBridge connects via an interface from servers 203 and 205 to the network 201 through VoIP to PBX Gateway 223 to Private Branch Exchange (PBX) 213 and then to Public Switched Telephone Network (PSTN) 215. The PSTN 215 can then connect to end-user devices such as Landline 219 and Cell Phone 221. Other devices connected to the Network 201, such as video conferencing equipment 217, can be connected to the Virtual World Program 223 in a similar manner. The person controlling the avatar 101 may then speak directly to the user, on for instance, cell phone 221.

Hardware and software configuration 200 also allows for a user in the real world to dial into the virtual world formed by Virtual World program 223. To place a call into the virtual world, the real world user of cell phone 221 places a call to a known phone number of PBX 213. PBX 213 then forwards the phone call through VoIP to PBX Gateway 223 and via network 201 to servers 203 and 205 where jVoiceBridge 229 of Virtual World program 223 can further prompt the call for a numerical phone extension, name, or other identifier of avatar 101 such as an email address.

Those of ordinary skill in the art would understand that the programming of which avatars are contacted could also be programmed in the PBX 213 and/or a combination of the jVoiceBridge, VoIP to PBX gateway 223 and PBX 213. It is further understood by those of ordinary skill in the art that Voice Over IP (VoIP) could be implemented in Network 201 and could also share the load for incoming and outgoing calls of a virtual world.

While not shown, it should be understood that a Virtual World program 223 has an interface link providing access between a real world and the virtual world. Such an interface link provides connection and input/output between servers 203 and 205 and workstations 207 and 209 as well as between servers 203 and 205 and PBX 213. The interface link is implemented across software, hardware and networking equipment and allows the interaction of various components of the system.

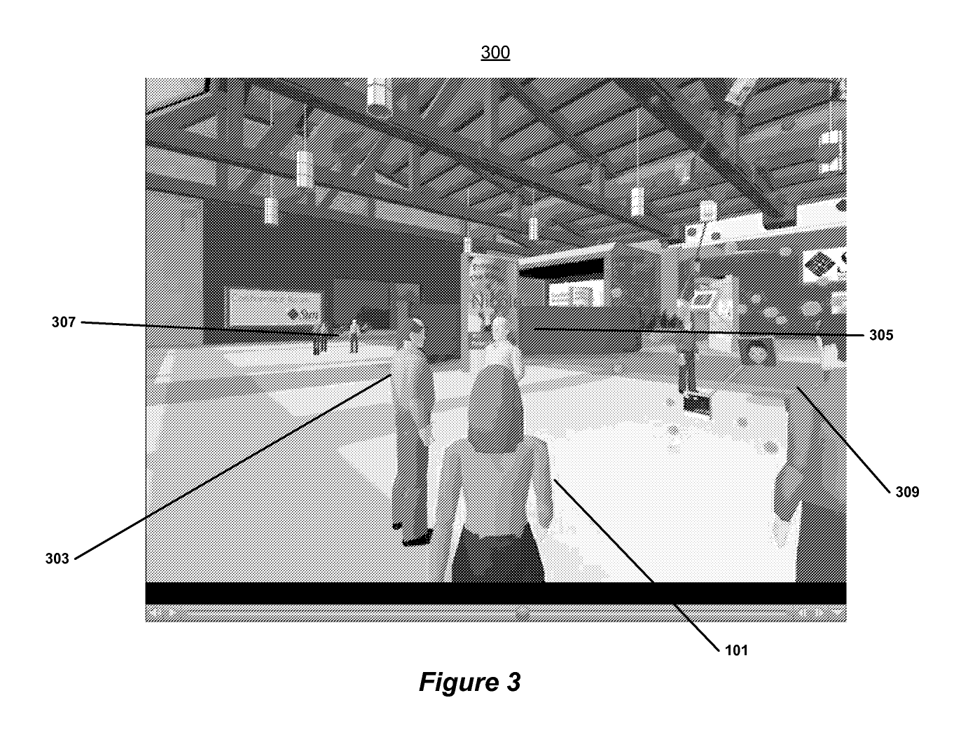

FIG. 3 is a rendering of virtual room 300 in a virtual world in which avatar 101 places an undetectable and unheard virtual phone call. In normal operation avatar 101 interacts with avatars 303, 305, and 309 by carrying on a conversation. Avatar 101 cannot carry on a conversation with the group of avatars 307, as avatars 307 are not in audio range of avatar 101. While avatar 101 may place a virtual phone call, it is in a “secret” state as none of the avatars 303, 305, 307 and 309 will hear the conversation, nor will there be any outward indication of the conversation visually detectable by avatars 303, 305, 307 and 309. In the virtual world conversations between avatars can follow the same rules as the real world. If an avatar is near you, you may hear and converse with them. If an avatar is far away, your ability to hear and converse with them is diminished or eliminated.

Avatar 101 representing the user of workstation 207 may also wish to make a phone call to a user of landline 219. When this occurs, avatar 101 is in audio range of avatars 303, 305 and 309, although she may wish to have the call undetected by those around her. The avatar may do so by walking to another unoccupied virtual room of a virtual world and placing the virtual phone call there. This option would allow another avatar 303 to follow avatar 101 to the other virtual room and overhear her conversation with the user of landline 219, which may not be the desired result. The user of workstation 207 may instead direct the Virtual World program 223 to place a phone call without allowing the avatars 303, 305 and 309 in audio range of avatar 101 to overhear her conversation. While the phone call is placed, avatars 303, 305 and 309 do not hear avatar 101 speaking to the user of landline 219 (i.e., a ‘secret’ state). Further, there is no other outward indication such as the presence of a virtual phone or other rendered graphic or text that would indicate the use of a virtual phone by avatar 101. In addition, the user of Landline 219 cannot hear any conversations in the virtual world other than the voice of the person represented by avatar 101.

It is obvious to anyone skilled in the art that all states can include teleconferencing equipment allowing multiple real-world users to be part of a virtual world conference.

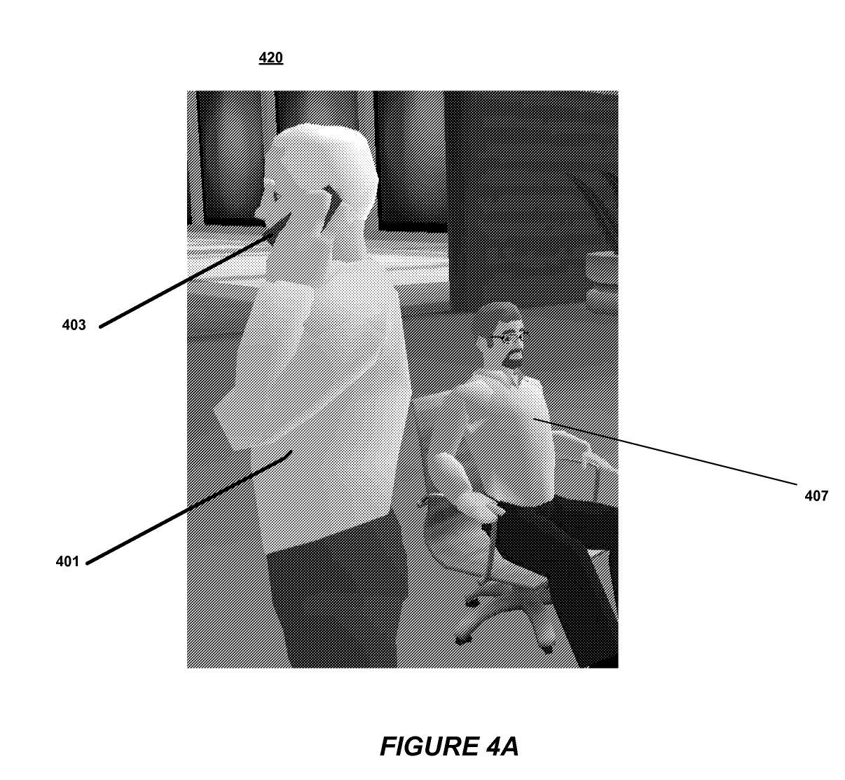

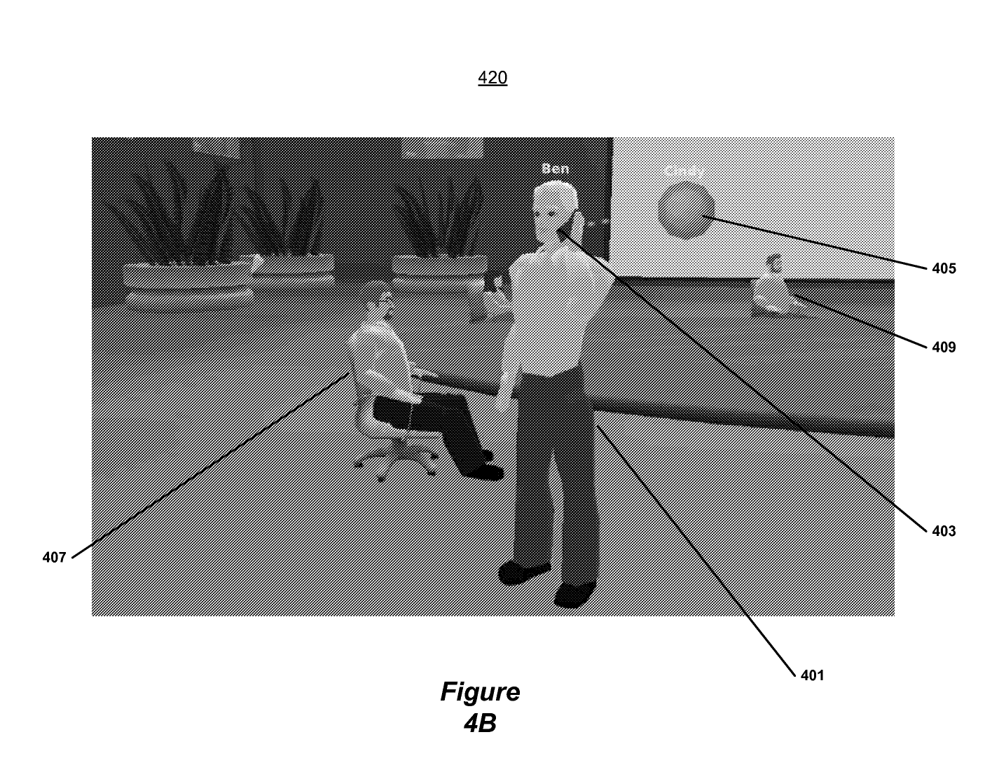

FIG. 4a is a rendering of virtual conference room 400 in which avatar 401 places a virtual phone call which can be detected by avatar 407 but is unheard or otherwise indiscernible (e.g., volume reduced or muted) by avatar 407 or any other avatars in audio range (proximity) to avatar 401 (i.e., a ‘private state). The user of workstation 207 directs the Virtual World program 223 to place a phone call without allowing the avatar 407 in audio range of avatar 401 to overhear his conversation. When the call is placed, virtual cell phone 403 may be rendered to indicate that avatar 401 is on the phone. While there is an outward indication of the placed virtual phone call by avatar 401, avatar 407 although in proximity of avatar 401 cannot hear the conversation. In addition, the user of Landline 219 cannot hear any conversations in the virtual world other than the voice of the person represented by avatar 101.

FIG. 4b is a rendering of virtual conference room 420, which is a larger view of virtual conference room 400, in which avatar 401 places a virtual phone call that can be detected by avatars 407 and 409. The phone call can be detected by the outward indications of avatar 401 using virtual cell phone 403. Further, object 405 indicates the user “Cindy” to whom avatar 401 is speaking. While avatars 407 and 409 have an indication as to whom avatar 401 is speaking, the conversation between “Cindy” and avatar 401 is unheard by avatars 407 and 409 despite avatars 407 and 409 being with audio range of avatar 401 (i.e., a “public/silent” state). “Cindy”, however, can hear the voices of avatars 407 and 409. It is understood by those of ordinary skill in the art the rendering of virtual cell phone 403 or object 405 could be replaced by another graphic or text indicating that the call is being placed. As there is indication as to whom avatar 401 is speaking, other avatars in audio range may request to join the conversation, and if the request is accepted, those avatars that made the request would join the conversation between avatar 401 and the real world user of landline 219.

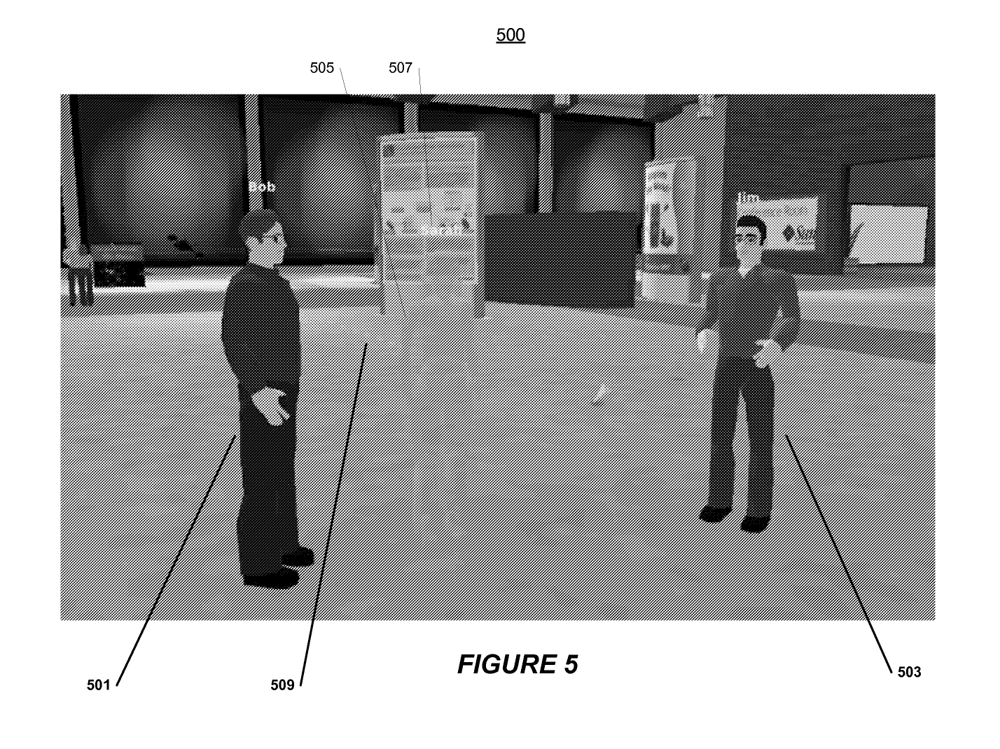

FIG. 5 is a rendering of virtual room 500 in which avatar 501 places a virtual phone call where the real world user is identified and the conversation is heard (i.e., a ‘public’ state). The user of workstation 207 directs the Virtual World program 223 to place a phone call that allows the avatar 503 in audio range of avatar 501 to overhear his conversation. There is no outward indication of a cell phone 403 as in FIG. 4. As such, it can be assumed that a virtual phone (not shown) is associated with virtual room 500 or with avatar 501. In this state, avatar 503 can determine to whom avatar 501 is speaking by a rendering of semi-transparent avatar 505 and associated name-tag 507, and can hear the voice of the person associated with semi-transparent avatar 505. Likewise, the person associated with semi-transparent avatar 505 can hear avatar 503. Either or both semi-transparent avatar 505 and name-tag 507 may be rendered to indicate the real world user. Once semi-transparent avatar 505 is rendered, avatar 501 becomes its navigational surrogate. Tether 509 is a visual indication that avatar 401 is the navigational surrogate of semi-transparent avatar 505. If avatar 501 transits across virtual room 500, semi-transparent avatar 505 and any other indication of the real world user follows avatar 501.

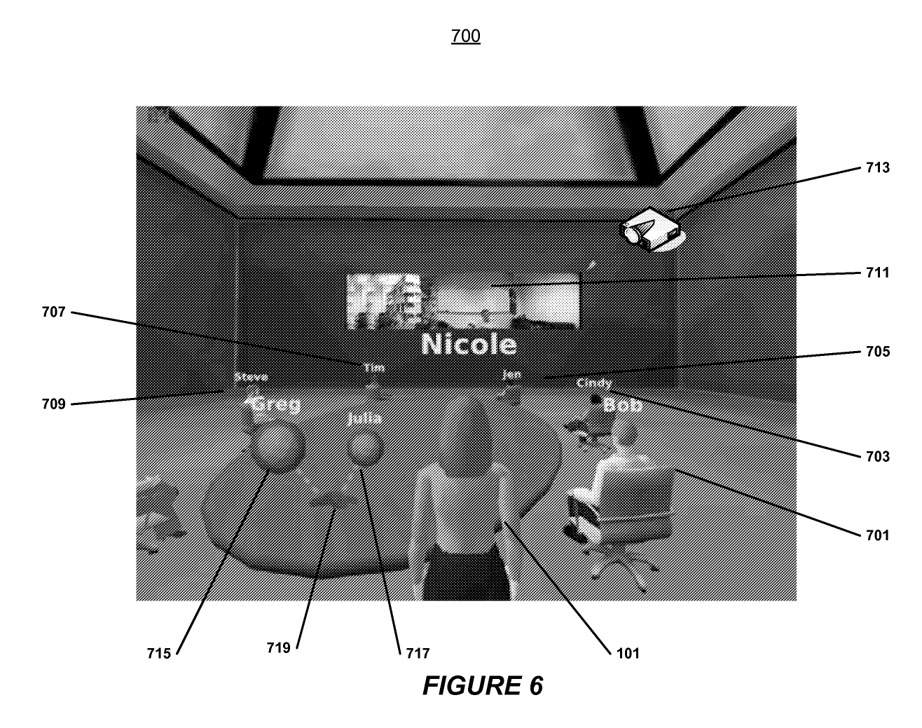

FIG. 6 is a rendering of a virtual world conference room in which a video-conference between avatars of a virtual world with individuals in the real world is held (i.e., a ‘public/video’ state). In virtual conference room 700 exists virtual conferencing equipment 713 that receives input from real world video conferencing equipment 217, which exists in a real world conference room. The real world video conferencing equipment records the images of real world person 711 in the real world conference room and transmits to a virtual screen 713 in the virtual conference room. The real world users represented by avatars 101 and 701, 703, 705, 707 and 709 can each view the image of real world person 711. The rendered image of the virtual conference room is transmitted to the real world video conferencing display (not shown) where real world person 711 sees the rendered virtual conference room with avatars 101 and 701, 703, 705, 707 and 709. The audio portion of the video conference is bi-directional being transmitted to and from both the virtual conference room and the real world conference room. Virtual world conference room 700 further includes objects 715 and 717 that are tethered to teleconferencing equipment 719. Objects 715 and 717 could likewise be tethered to virtual world conference room 700 or any of avatars 701, 703, 705, 707 and 709. Teleconferencing equipment 719 allows multiple real world users to be part of a virtual world conference.

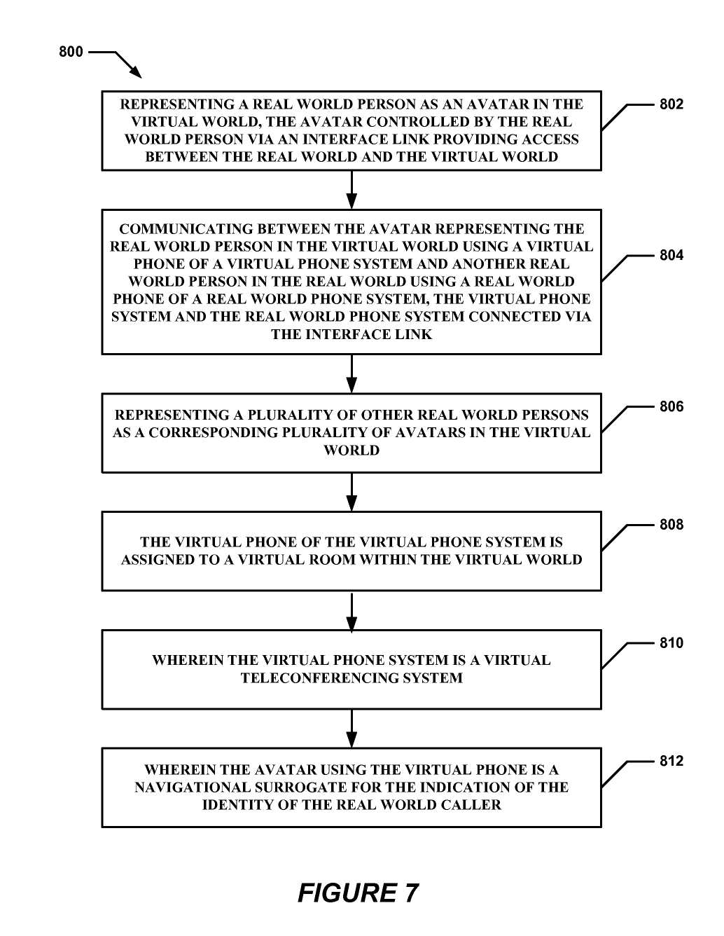

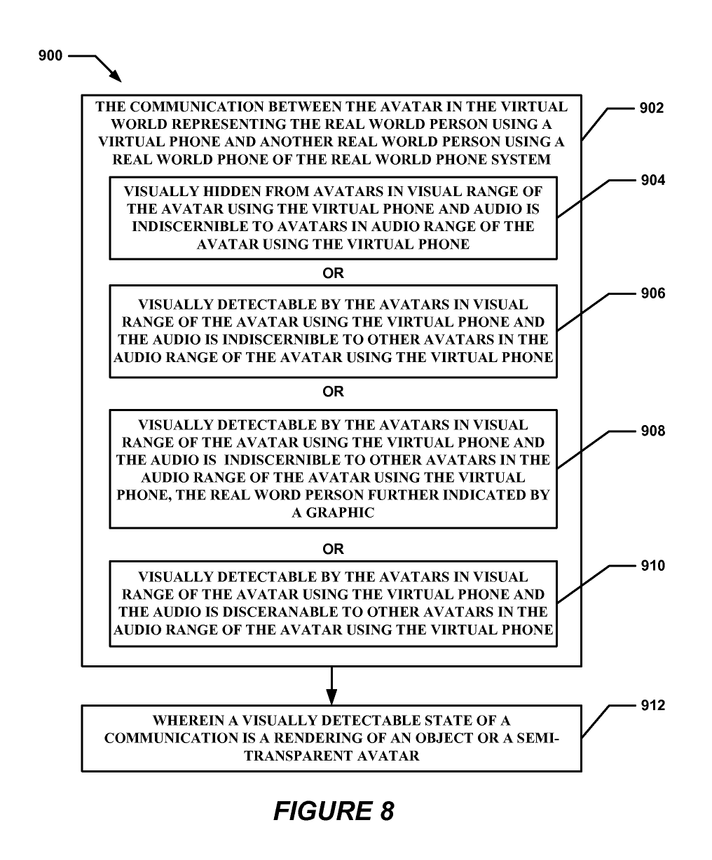

Flow charts of the presently disclosed methods are depicted in FIGS. 7 and 8. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

FIG. 7 comprises a flow diagram of a particular embodiment 800 of a method of communicating between a virtual world and real world. Processing begins with processing block 802 which discloses representing a real world person as an avatar in a virtual world. The avatar typically has a name associated therewith for indication as to the identity of the avatar and/or the real world person controlling the avatar. The avatar is controlled by a real world person via an interface link providing access between the real world and the virtual world.

Processing block 804 states communicating between the avatar representing the real world person in the virtual world using a virtual phone of a virtual phone system and another real world person in the real world using a real world phone of a real world phone system, the virtual phone system and the real world phone system connected via the interface link.

Processing block 806 recites representing a plurality of other real world persons as a corresponding plurality of avatars in the virtual world. Each of these avatars may also have a respective name associated therewith for indication as to the identity of the avatar and/or the real world person controlling the avatar. These avatars are also controlled by real world people via an interface link providing access between the real world and the virtual world.

Processing continues with processing block 808 which discloses the virtual phone of the virtual phone system is assigned to a virtual room within the virtual world. Processing block 810 states the virtual phone system is a virtual teleconferencing system. The virtual teleconferencing system allows a group of avatars to communicate with one or more real world people.

Processing block 812 discloses the avatar using the virtual phone is a navigational surrogate for the indication of the identity of the real world caller. If the avatar using the virtual phone transits across a virtual room 500, the identity of the real world caller follows the avatar using the virtual phone. As there is indication as to whom the avatar using the virtual phone is speaking, other avatars in audio range may request to join the conversation, and if the request is accepted, those avatars that made the request would join the conversation between the avatar using the virtual phone and the real world person the avatar is communicating with

Referring now to FIG. 8 particular embodiment of a method 900 of representing the communication between the avatar and a real world person is shown. Method 900 begins with processing block 902 which states the communication between the avatar in the virtual world representing the real world person using a virtual phone and another real world person using a real world phone of the real world phone system is selected from one of the four different presentations listed in processing blocks 904, 906, 908 and 910.

Processing block 904 recites the communication is visually hidden from avatars in visual range of the avatar using the virtual phone and audio is indiscernible to avatars in audio range of the avatar using the virtual phone (i.e., a ‘secret’ state). Thus, in this instance, other avatars are unaware that the avatar using the virtual phone is communicating with another person.

Processing block 906 discloses the communication is visually detectable by the avatars in visual range of the avatar using the virtual phone and the audio is indiscernible to other avatars in the audio range of the avatar using the virtual phone. In this instance, the other avatars can see that the avatar using the virtual phone is in communication with someone, but are not able to hear the conversation taking place between the avatar using the virtual phone and the other party (i.e., a ‘private’ state). The audio may be of such low volume as to make the audio indiscernible to the other avatars or the audio may be muted.

Processing block 908 states the communication is visually detectable by the avatars in visual range of the avatar using the virtual phone and the audio is indiscernible to other avatars in the audio range of the avatar using the virtual phone, the real word person further indicated by a graphic. In this instance, the other avatars can see that the avatar using the virtual phone is in communication with someone, but are not able to hear the conversation taking place between the avatar using the virtual phone and the other party (i.e., a ‘public/silent’ state). The audio may be of such low volume as to make the audio indiscernible to the other avatars or the audio may be muted. The other avatars may also be aware of the identity of the other party the avatar using the virtual phone is communicating with.

Processing block 910 recites the communication is visually detectable by the avatars in visual range of the avatar using the virtual phone and the audio is discernable to other avatars in audio range of the avatar using the virtual phone. In this instance the other avatars are not only aware of the other party the avatar using the virtual phone is communicating with, but can also hear the audio communication between the avatar using the virtual phone and the other party (i.e., a ‘public’ state). The other party may also hear the avatars in the audio range. In some of the states, communication is a two-way channel, such as public. In other states, such as private, communication is not a two-way channel. In another example embodiment, the other avatars are not only aware of the other party the avatar using the virtual phone is communicating with, but can also view the video communication between the avatar using the virtual phone and the other party (i.e., a ‘public/video’ state).

Processing block 912 discloses wherein a visually detectable state of a communication is a rendering of one of the group comprising an object and a semi-transparent avatar. The other party the avatar using the virtual phone is communicating with may be represented by an object (e.g., a floating orb) with a name identifying the other party next to the object. The object may alternately be represented by a semi-transparent avatar, thus providing an indication that the avatar is not present but is in communication by way of the telephone call taking place.

The figures above were described in reference to avatar 101 placing a virtual phone call. It is well understood by those of ordinary skill in the art that an avatar receiving a phone call could as easily set the same states as enumerated above on the receipt of the phone call from a real world person in the real world.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation. Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein. Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Those skilled in the art will understand that there can be many variations made to the operations of the user interface explained above while still achieving the same objectives of the invention. Such variations are intended to be covered by the scope of this invention. As such, the foregoing description of embodiments of the invention are not intended to be limiting. Rather, any limitations to embodiments of the invention are presented in the following claims.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of communicating between a representation of a person in a virtual world and a real person in a real world, the method comprising:
representing a real world person as an avatar in the virtual world, the avatar controlled by the real world person via an interface link providing access between the real world and the virtual world; and
communicating between the avatar representing the real world person in the virtual world using a virtual phone of a virtual phone system and another real world person in the real world using a real world phone of a real world phone system, the virtual phone system and the real world phone system connected via the interface link.

2. The method of claim 1, further comprising:
representing a plurality of other real world persons as a corresponding plurality of avatars in the virtual world.

3. The method of claim 2, wherein the communication between the avatar in the virtual world representing the real world person using a virtual phone and another real world person using a real world phone of the real world phone system, the communication having selectively at least one of a state of:
visually hidden from avatars in visual range of the avatar using the virtual phone and audio is indiscernible to avatars in audio range of the avatar using the virtual phone;
visually detectable by the avatars in visual range of the avatar using the virtual phone and the audio is indiscernible to other avatars in the audio range of the avatar using the virtual phone;
visually detectable by the avatars in visual range of the avatar using the virtual phone and the audio is indiscernible to other avatars in the audio range of the avatar using the virtual phone, the real word person further indicated by a graphic;
visually detectable by the avatars in visual range of the avatar using the virtual phone and the audio is discernable to other avatars in audio range of the avatar using the virtual phone, the real word person further indicated by a graphic; and
visually detectable by the avatars in visual range of the avatar using the virtual phone and a video is discernable to other avatars in audio range of the avatar using the virtual phone.

4. The method of claim 3, wherein a visually detectable state of a communication is a rendering of one of the group comprising an object representing the other party the avatar is in communication with and a semi-transparent avatar representing the other party the avatar is in communication.

5. The method of claim 2, wherein the virtual phone of the virtual phone system is assigned to a virtual room within the virtual world.

6. The method of claim 5, wherein the virtual phone system is a virtual teleconferencing system.

7. The method of claim 2, wherein the avatar using the virtual phone is a navigational surrogate for the indication of the identity of the real world caller.

8. A system for communicating between a representation of a real world person and a real world person, the system comprising:
an interface link providing access between a real world and the virtual world;
a real world phone system;
an avatar in the virtual world representing a corresponding person in the real world, the avatar controlled via the interface link by the corresponding real world person;
a virtual phone system connected via the interface link to the real world phone system, the virtual phone system allowing communication between the avatar in the virtual world representing the real world person using a virtual phone and another real world person using a real world phone of the real world phone system; and
a computer system comprising:
a memory;
a processor;
a communications interface;
an interconnection mechanism coupling the memory, the processor and the communications interface; and
wherein the memory is encoded with an application providing communicating between a representation of a person in a virtual world and a real person in a real world, that when performed on the processor, provides a process for processing information, the process causing the computer system to perform the operations of:
representing a real world person as an avatar in the virtual world, the avatar controlled by the real world person via an interface link providing access between the real world and the virtual world; and
communicating between the avatar representing the real world person in the virtual world using a virtual phone of a virtual phone system and another real world person in the real world using a real world phone of a real world phone system, the virtual phone system and the real world phone system connected via the interface link.

9. The system of claim 8, further comprising representing a plurality of other real world persons as a corresponding plurality of avatars in the virtual world.

10. The system of claim 9, wherein the communication between the avatar in the virtual world representing the real world person using a virtual phone and another real world person using a real world phone of the real world phone system, the communication having selectively at least one of a state of:
visually hidden from avatars in visual range of the avatar using the virtual phone and audio is indiscernible to avatars in audio range of the avatar using the virtual phone;
visually detectable by the avatars in visual range of the avatar using the virtual phone and the audio is indiscernible to other avatars in the audio range of the avatar using the virtual phone;
visually detectable by the avatars in visual range of the avatar using the virtual phone and the audio is indiscernible to other avatars in the audio range of the avatar using the virtual phone, the real word person further indicated by a graphic;
visually detectable by the avatars in visual range of the avatar using the virtual phone and the audio is discernable to other avatars in audio range of the avatar using the virtual phone, the real word person further indicated by a graphic; and
visually detectable by the avatars in visual range of the avatar using the virtual phone and a video is discernable to other avatars in audio range of the avatar using the virtual phone.

11. The system of claim 10, wherein a visually detectable state of a communication is a rendering of one of the group comprising an object and a semi-transparent avatar.

12. The system of claim 9, wherein the virtual phone of the virtual phone system is assigned to a virtual room within the virtual world.

13. The system of claim 12, wherein the virtual phone system is a virtual teleconferencing system.

14. The system of claim 9, wherein the avatar using the virtual phone is a navigational surrogate for the indication of the identity of the real world caller.

15. A computer readable medium having computer readable code thereon for executing on a computer the method of communicating between a representation of a person in a virtual world and a real person in a real world, the computer readable medium comprising:
instructions for representing a real world person as an avatar in the virtual world, the avatar controlled by the real world person via an interface link providing access between the real world and the virtual world; and
instructions for communicating between the avatar representing the real world person in the virtual world using a virtual phone of a virtual phone system and another real world person in the real world using a real world phone of a real world phone system, the virtual phone system and the real world phone system connected via the interface link.

16. The computer readable medium of claim 15, further comprising:
instructions for representing a plurality of other real world persons as a corresponding plurality of avatars in the virtual world.

17. The computer readable medium of claim 16, further comprising instructions wherein the communication between the avatar in the virtual world representing the real world person using a virtual phone and another real world person using a real world phone of the real world phone system, the communication having selectively at least one of a state of:
visually hidden from avatars in visual range of the avatar using the virtual phone and audio is indiscernible to avatars in audio range of the avatar using the virtual phone;
visually detectable by the avatars in visual range of the avatar using the virtual phone and the audio is indiscernible to other avatars in the audio range of the avatar using the virtual phone;
visually detectable by the avatars in visual range of the avatar using the virtual phone and the audio is indiscernible to other avatars in the audio range of the avatar using the virtual phone, the real word person further indicated by a graphic; and
visually detectable by the avatars in visual range of the avatar using the virtual phone and the audio is discernable to other avatars in audio range of the avatar using the virtual phone, the real word person further indicated by a graphic.

18. The computer readable medium of claim 17, further comprising instructions wherein a visually detectable state of a communication is a rendering of one of the group comprising an object and a semi-transparent avatar.

19. The computer readable medium of claim 15, further comprising instructions wherein the virtual phone of the virtual phone system is assigned to a virtual room within the virtual world.

20. The computer readable medium of claim 16, further comprising instructions wherein the avatar using the virtual phone is a navigational surrogate for the indication of the identity of the real world caller.
